(19) United States
(12) Patent Application Publication
(10) Pub. No.: US 2015/0219571 A1
(43) Pub. Date: Aug. 6, 2015

(54) APPARATUS AND METHOD FOR DETECTING IMPURITY IN NON-POLAR MATERIALS

(71) Applicant: Joseph R. Damers, Pasadena, CA (US)

(72) Inventor: Joseph R. Demers, Pasadena, CA (US)

(21) Appl. No.: 14/172,593

(22) Filed: Feb. 4, 2014

(51) Int. Cl. G01N 21/94; G01N 21/49; G01N 21/59

(52) U.S. Cl. CPC G01N 21/94; G01N 21/59; G01N 21/49

(57) ABSTRACT

Highly advantageous impurity detectors and methods are disclosed for detecting impurities in non-polar materials using terahertz frequency electromagnetic radiation to irradiate the non-polar materials and detecting radiation emergent from the non-polar material responsive to the irradiating to determine impurity characteristics.

### FIELD OF THE INVENTION

The invention generally relates to detecting impurities in non-polar materials and more particularly to utilizing terahertz frequency electromagnetic radiation for detecting polar and non-polar impurities in the non-polar materials.

### BACKGROUND

Monitoring the integrity of materials can be extremely important for equipment and human safety in a variety of fields. In some instances, impurities in materials can be indicative of imminent equipment failure; in other instances, impurities in materials can indicate a degradation of important properties of the material.

Large engines are used for driving ships, airplanes and mining equipment as well as electrical generation for trains and other industrial and life support purposes. Failure of these engines can be expensive in terms of lost productivity and repair costs and can be disastrous if engine failure occurs in an airplane or life support power generator, for instance. Engines rely on some type of material for lubrication to minimize friction between components, to maintain a relatively low operating temperature, and to prevent the failure of the components. These lubrication materials can degrade over their operational lifetime. As these lubricants degrade, impurities which can be caused by the breakdown of the lubricants can increase in concentration in the lubricant and the lubricating efficacy of the material can be diminished by these impurities. This lubricant degradation can lead to heat buildup in the engine, premature engine wear and even engine failure.

Lubricant and other materials can also become contaminated by particle impurities. Some particle impurities can be metal particles that are the result of component breakdown in the machine. These metal particles can be an important indication that a machine has been subjected to damage that is not the result of normal wear and tear. In these instances, the machine may need repair or replacement to continue safe operation of the machine.

Internal combustion engines rely on a fuel material that is typically in liquid form for operation. Impurities can contaminate the fuel and can render the fuel less effective or can make it difficult or impossible to combust the fuel. When such a situation arises in the context of an airplane or an emergency generator, the results can be dangerous or fatal.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a method and associated apparatus are described for detecting an impurity in an essentially non-polar material. In an embodiment, the non-polar material is irradiated with a beam of electromagnetic radiation having at least one frequency in a range of about 100 GHz to about 10 THz such that at least a portion of the electromagnetic radiation beam interacts with the impurity in the non-polar material such that electromagnetic radiation emerges from the non-polar material. An intensity level of the emergent electromagnetic radiation is detected from the nonpolar material. An impurity characteristic is identified in the non-polar material based, at least in part, on the detected intensity level of the electromagnetic radiation as influenced by the interaction of the electromagnetic radiation beam with the impurity.

In another embodiment, a method and associated apparatus are described for detecting an impurity in a carbon-based material. In this method, the carbon-based material is irradiated with a beam of electromagnetic radiation having at least one frequency in the range of about 100 GHz to about 10 THz. The carbon-based material is irradiated such that at least a portion of the electromagnetic radiation beam interacts with the impurity in the carbon-based material to cause the impurity to produce a scattered electromagnetic radiation. The scattered electromagnetic radiation is detected from the carbon-based material. An intensity level of the detected scattered electromagnetic radiation is determined. An impurity characteristic of the carbon-based material is identified based, at least in part, on the determined intensity level of the detected scattered electromagnetic radiation.

In yet another embodiment, a method and associated apparatus are described for detecting an impurity in a non-polar material. The non-polar material is irradiated with a beam of electromagnetic radiation having at least one frequency in the range of about 100 GHz to about 10 THz. The non-polar material is irradiated such that one portion of the electromagnetic radiation beam is absorbed by the impurity in the non-polar material and another portion of the electromagnetic radiation is transmitted through the non-polar material. At least part of the transmitted portion of the electromagnetic radiation from the nonpolar material is detected and an intensity level of the detected electromagnetic radiation is determined. An impurity characteristic of the impurity in the non-polar material is identified based, at least in part, on the determined intensity level of the detected electromagnetic radiation.

In another embodiment, a method and associated apparatus are described for detecting an impurity in a non-polar material. The non-polar material is irradiated with a beam of electromagnetic radiation having at least one frequency in the range of about 100 GHz to about 10 THz. The non-polar material is irradiated such that one portion of the electromagnetic radiation beam is reflected by the impurity in the non-polar material and another portion of the electromagnetic radiation is transmitted through the non-polar material. At least part of the reflected portion of the electromagnetic radiation from the nonpolar material is detected and an intensity level of the detected electromagnetic radiation is determined. An impurity characteristic of the impurity in the non-polar material is identified based, at least in part, on the determined intensity level of the detected electromagnetic radiation.

In another embodiment, an impurity detector is disclosed for detecting an impurity in a nonpolar material. The device includes a terahertz frequency electromagnetic radiation beam source that is configured to produce an electromagnetic radiation beam having at least one frequency in a range of about 100 GHz to about 10 THz. The beam source is arranged to irradiate the non-polar material such that terahertz frequency electromagnetic radiation emerges from the non-polar material in response to the irradiation. The device includes a terahertz frequency detector that is arranged to receive at least a portion of the emergent terahertz frequency electromagnetic radiation. The detector produces a detector signal responsive to receiving the emergent radiation such that the detector signal contains information related to a characteristic of the impurity. The device includes a controller that is configured to receive the detector signal and to use the detector signal to identify the impurity characteristic.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a diagrammatic drawing of an embodiment of an impurity detector which can be used for detecting an impurity in a nonpolar material.

FIG. 2 is a flow diagram illustrating an embodiment of a method for detecting an impurity in a nonpolar material using the impurity detector.

FIG. 3 is a graph illustrating results which can be obtained using the method disclosed in conjunction with FIG. 2.

FIG. 4 is another graph illustrating results which can be obtained using the method disclosed in conjunction with FIG. 2.

FIG. 5 is yet another graph illustrating results which can be obtained using the method disclosed in conjunction with FIG. 2.

FIG. 6 is a diagrammatic drawing of another embodiment of an impurity detector that can be used for detecting an impurity in a nonpolar material.

FIG. 7 is a flow diagram illustrating an embodiment of another method for detecting an impurity in a nonpolar material using the impurity detector.

FIG. 8 is a flow diagram illustrating yet another embodiment of a method for detecting an impurity in a nonpolar material using the impurity detector.

FIG. 9 is a flow diagram illustrating still another embodiment of a method for detecting an impurity in a nonpolar material using the impurity detector.

FIG. 10 is a diagrammatic illustration of an embodiment of an optical system which can be incorporated as part of the impurity detector for generating and detecting terahertz frequency electromagnetic radiation.

FIG. 11 is a diagrammatic illustration of another embodiment of an optical system which can be incorporated as part of the impurity detector for generating and detecting terahertz frequency electromagnetic radiation.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the Figures, and is in no way intended as being limiting.

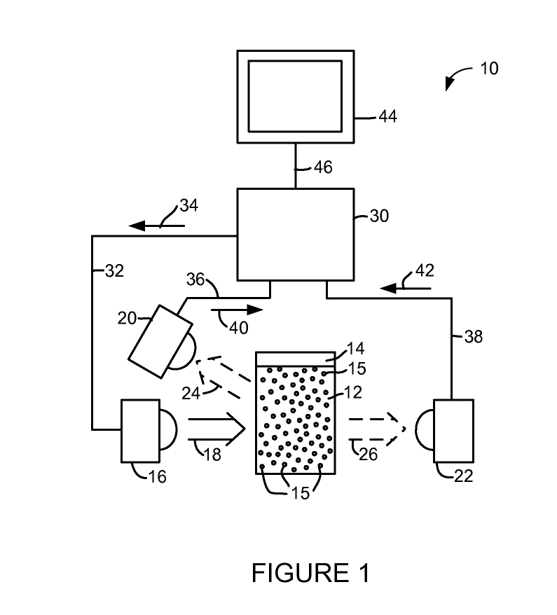

Attention is now directed to the Figures wherein like items may refer to like components throughout the various views. FIG. 1 is a diagrammatic representation of an impurity detector, corresponding to an embodiment of the present disclosure, and generally indicated by the reference number 10. The impurity detector can be used for detecting impurities in non-polar samples using Terahertz (THz) radiation. In an embodiment, the impurity detector can be used for detecting the breakdown of hydrocarbon or fluorocarbon lubricants, oils, fuels or additives based on changes in the sample polarity. The impurity detector can also be used to detect other types of polar impurities, such as water, in the non-polar sample. The impurity detector can also be used to determine the presence of soot and metal particles in non-polar liquids, solids and vapors.

In the present embodiment, a sample of non-polar material 12 is placed in a test container 14 which is then positioned for analysis in detector 10. Non-polar material, as the term is used herein, should be understood to include materials that are substantially without any polar characteristic in their purest form, and which may also include one or more types of impurities that may or may not be polar. Non-polar material 12 includes an impurity 15 which can have one or more impurity characteristics such as a concentration in the non-polar material, radiation absorption characteristics, radiation reflection characteristics and/or radiation scattering characteristics, or other characteristics. Applicants recognize that the impurity characteristics can be unique to the type of impurity and can therefore be used to identify the type of impurity. Non-polar materials can be natural and/or synthetic lubricants, fuels, such as for instance, diesel, gasoline, airplane fuels and other materials. Hydrocarbons and fluorocarbons are generally non-polar materials. Applicants have discovered and empirically demonstrated that terahertz electromagnetic radiation in a frequency range of about 100 GHz to about 10 THz passes through non-polar materials substantially without attenuation and such materials can therefore be considered as transparent to the terahertz radiation. For purposes of the techniques described herein, unless otherwise indicated, terahertz radiation refers to frequencies in the range of from about 0.01 THz (100 GHz) to about 10 THz (10,000 GHz).

Impurity detector 10 includes an electromagnetic beam source 16 which can selectively generate and emit a beam of electromagnetic radiation 18 having at least one frequency in the range of about 100 GHz to about 10 THz. Beam source 16 can produce continuous wave or pulsed radiation. Impurity detector 10 can include a scattered/reflection detector 20 and/or a transmission detector 22 depending on the type or types of impurities that device 10 is used to detect. The non-polar material is positioned such that the electromagnetic radiation beam irradiates at least a portion of the non-polar material. Scattered/reflection detector 20 can detect scattered and/or reflection electromagnetic radiation 24 resulting from the scattering and/or reflection of electromagnetic radiation beam 18 by impurities in the non-polar material. Transmission detector 22 can detect a transmitted electromagnetic radiation 26 which results from at least a portion of electromagnetic radiation beam 18 that has passed through non-polar material 12 substantially without interaction with impurity 15.

Impurity detector 10 can include a controller 30. Controller 30 can control beam source 16 using a signal 34 through a control line 32 of device 10. Controller 30 can turn the beam source on and off; can control the frequency or frequencies that are generated by beam source 16; and can control beam 18 as either a continuous wave or pulsed radiation. Electromagnetic radiation beam 18 can include different frequencies at different times, such as, for example, by scanning the frequency through a range of frequencies. Beam 18 can include different frequencies that are distinct, separate frequencies from one another and the beam can be incremented or stepped through these separate frequencies during operation of the detector so that impurities having characteristics that are identifiable by these separate frequencies can be identified either through transmission, reflection, or scattering. A single frequency in the terahertz range can be used in the beam when the radiation at that single frequency interacts with an impurity in a detectable way. Electromagnetic radiation beam 18 can also be produced as one or more pulses in which case the beam includes a plurality of different frequencies within a range.

Detector 10 can include data line 36 to carry data signal 40 from detector 20 to the controller; and can include data line 38 to carry data signal 42 from detector 22 to the controller. Data signal 40 is generated in response to detector 20 receiving scattered/reflected radiation 24 and data signal 42 is generated in response to detector 22 receiving transmitted radiation 26. Impurity detector 10 can include a monitor 44 connected to the controller with a cable 46. Monitor 44 is exemplary of devices for viewing the results of the impurity detection, although other devices may be used for viewing, manipulating, or otherwise utilizing the information gained from the impurity detector.

Detector 10 can irradiate the non-polar material and can detect transmitted, reflected, and/or scattered radiation from the non-polar material and can produce spectral and/or image data which can be analyzed to determine if an impurity is present in the non-polar material. Detector 10 can be used for determining characteristic information about impurities in the non-polar material. While some embodiments are discussed with regard to lubricants and detecting impurities therein, it should be appreciated that these techniques may also be applied to other applications, such as for instance: detecting the percentage of a reactant in a chemical reaction; detecting the amount of soot in a column of smoke or exhaust; determining the homogeneity of a chemical in a mixture given the physical size of the undissolved chemical; determining the size of particulate matter in a liquid, solid, or vapor; and/or other applications.

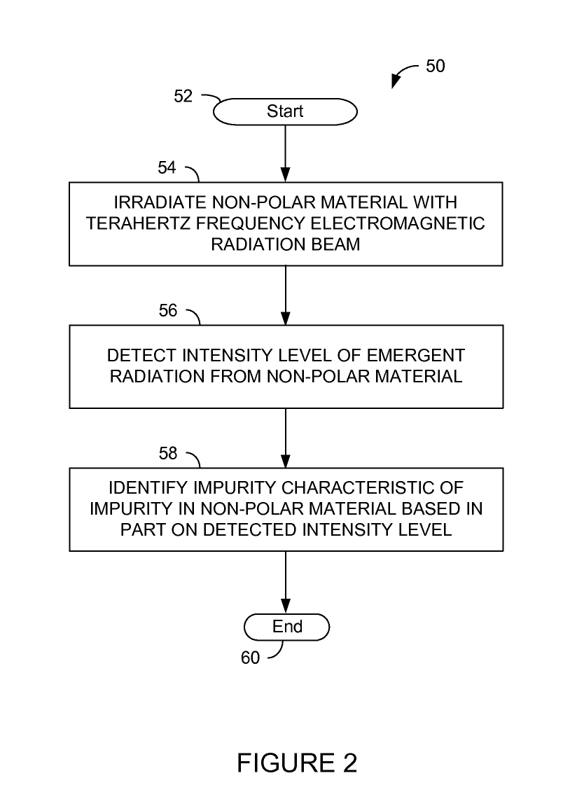

Referring now to FIG. 2 in conjunction with FIG. 1, a method 50 is shown for detecting an impurity in an essentially non-polar material. Method 50 can utilize the embodiment of the impurity detector shown in FIG. 1 or other embodiments. Method 50 begins at start 52 and then proceeds to 54 where non-polar material 12 is irradiated with electromagnetic radiation beam 18. The electromagnetic radiation beam includes at least one frequency in a range of about 100 GHz to about 10 THz. At least a portion of the electromagnetic radiation beam interacts with the impurity in the non-polar material. Irradiating the non-polar material with the electromagnetic radiation beam causes electromagnetic radiation to emerge from the non-polar material. The emergent electromagnetic radiation from the non-polar material can be a portion of the radiation from the beam that passes through (also referred to as transmitted through) the non-polar material substantially without interacting with the impurity. The emergent radiation that is transmitted through the non-polar material can have a relationship to the amount of impurities having an absorption characteristic for Terahertz radiation, such as, for instance, polar impurities. When the non-polar material contains more or a higher concentration of impurities with the terahertz absorption characteristic, more of the terahertz radiation beam is absorbed by the impurities and less of the terahertz beam is transmitted through the non-polar material. The emergent electromagnetic radiation from the non-polar material can be a portion of the radiation from the beam that is reflected from one or more impurities in the non-polar material, and/or radiation resulting from Mie scattering. In the present disclosure, as well as the appended claims, it should be appreciated that the term “emerging electromagnetic radiation” and like terms refer to electromagnetic radiation that emerges from the sample material responsive to any of these mechanisms: transmission, reflection and/or scattering. Method 50 then proceeds to 56 where an intensity level of the emergent electromagnetic radiation is detected. Method 50 then proceeds to 58 where an impurity characteristic of the impurity in the nonpolar material is identified based, at least in part, on the detected intensity level of the electromagnetic radiation as influenced by the interaction of the electromagnetic radiation beam with the impurity. Method 50 then proceeds to 60 where the method ends.

The impurity characteristic can be used to identify the type of impurity in the non-polar material as well as the quantity or concentration of the impurity in the material. In some embodiments, the non-polar material is a lubricant and the impurity characteristic is a polar impurity characteristic. The presence of polar impurity in the non-polar lubrication material can be indicative of the degradation of the lubricant. Since the polar material can absorb electromagnetic radiation in the frequency range of the electromagnetic radiation beam, some of the electromagnetic radiation beam will be absorbed by the polar impurity while some of the beam will pass or transmit through the non-polar material substantially unaffected. The intensity level of the detected electromagnetic radiation that is transmitted through the non-polar material can be indicative of the level or concentration of the polar impurity in the non-polar lubrication material. Polar impurities can decrease the efficacy of the non-polar lubrication material. The level or concentration of the polar impurity in the non-polar lubrication material can be used to determine whether or not the lubrication material is still an effective lubricant for the engine or other machine from which the sample of non-polar lubrication material was taken.

Hydrocarbons, such as those used for lubrication, can contain some other atoms besides hydrogen and carbon but are generally made up of long chain hydrogen-carbon molecules. These hydrocarbons in their non-contaminated state are generally non-polar in that the molecules in the material either have a nonexistent or very small dipole moment. Breakdown of the hydrocarbon lubricant material generally occurs in the breaking of the long-chain hydrocarbon molecules into ionic compounds having a dipole moment. This breakdown increases the overall polarity of the material. Fluorocarbon-based materials used for lubrication include additives that are soluble in the fluorocarbon and that give the material lubricity properties. These fluorocarbon materials are also substantially non-polar. When fluorocarbon-based lubrication breaks down, it is the additives in the fluorocarbon material that are breaking down. When the additives break down, they form ionic compounds which increase the polarity of the fluorocarbon material. Applicants recognize that, as hydrocarbon and fluorocarbon lubricants breakdown, the increase in polarity of these materials caused by the breakdown causes a corresponding increase in absorption of applied electromagnetic radiation in the 100 GHz to 10 THz range.

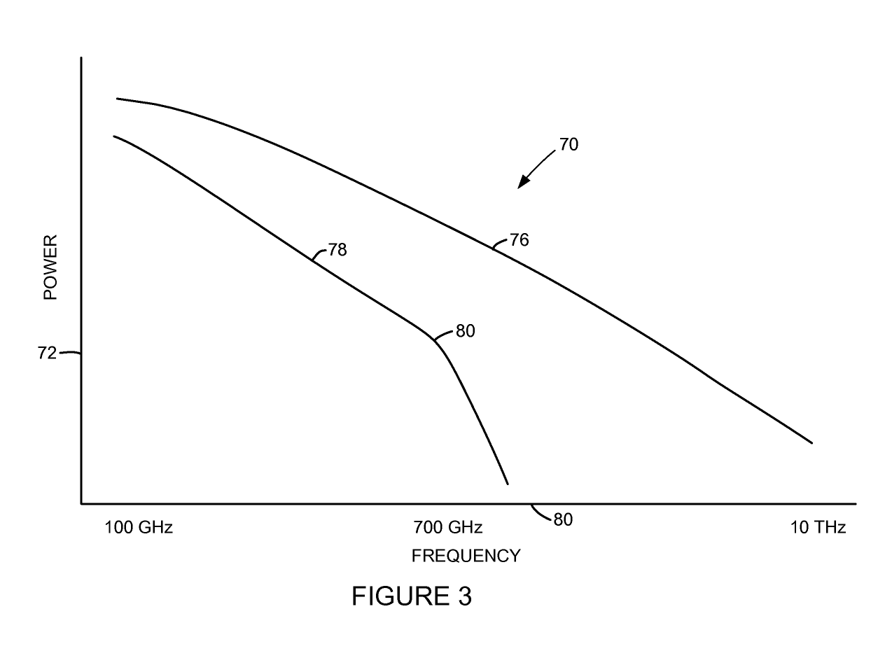

Referring now to FIG. 3 in conjunction with FIGS. 1 and 2, a graph 70 shows data which illustrates an embodiment in which the breakdown of non-polar material can be determined. In the present embodiment, that portion of electromagnetic radiation beam 18 from beam source 16 that passes through the non-polar material substantially without interaction with the impurity is transmitted radiation 26. Graph 70 includes an intensity level or power 72 of transmitted radiation 26 plotted against frequency 80 of electromagnetic radiation beam 18 in a range of about 100 GHz to about 10 THz.

In one embodiment, the electromagnetic beam source produces the electromagnetic radiation beam as a single frequency that is swept through a range of frequencies over a period of time. In another embodiment, the electromagnetic beam source can generate a single frequency beam, at least to an approximation, or can generate a beam that steps through multiple discrete frequencies within the range. The impurity detector can also use smaller sub-ranges that are within the 100 GHz to 10 THz range. Frequencies of the electromagnetic radiation beam can be selected based on transmission intensity level through the material. The frequencies can also be selected based on reflectivity, absorption and/or scattering produced by impurities.

A plot 76 shows the intensity level detected at transmission detector 22 in a range of frequencies for a non-polar material that is essentially free of impurities. Plot 76 can serve as a baseline for expected results from a clean lubricant material that is substantially free of impurities and other plot lines can be compared to the baseline (e.g., difference) for determining the impurity characteristic. Plot 78 shows an intensity level detected at transmission detector 22 in a range of frequencies for a used lubricant material which has polar impurities caused by breakdown. As can be seen based on graph 70, when the lubricant material breaks down, the intensity level of transmitted radiation 26 decreases relative to the fresh material. That is, for any given frequency, the intensity level in plot 78 is lower than a corresponding intensity level in plot 78. While not intending to be bound by theory, it is submitted that the intensity level decreases because the molecules that have broken down, which can be referred to as contaminants or impurities, exhibit a dipole moment and now absorb electromagnetic radiation in the 100 GHz to 10 THz range. Applicant submits that there is a direct correlation between the amount of polar material in the lubricant and the intensity level of the electromagnetic radiation beam. Therefore, the quality degradation or contamination level of the material can be determined by measuring the intensity level of the beam transmitted through the material.

Still referring to FIG. 3, plot 78 includes a transition or knee 80, corresponding to a frequency of about 700 GHz, where a slope of the line transitions to a steeper curve thereby indicating a decrease in transmission of radiation having frequencies above the transition. While not intending to be bound by theory, Applicant submits that this transition and decreased transmission represents an additional interference with the passing of the electromagnetic radiation beam through the non-polar material caused by soot particles in the material. Soot tends to be of a particle size that can produce Mie scattering. Radiation that is reflected or scattered is not typically detected by transmission detector 22 but it can be detected by reflection/scattering detector 20.

The sample of non-polar material can be taken from a larger production volume and provided to the impurity detector via a suitable delivery mechanism such as, for example, a vial or test tube. The non-polar material can also be examined in a deliverable form such as, for example, by integrating the impurity detector into an in-field test and/or maintenance system. The non-polar material may also be in a packaged form where the sample is housed in a container intended for delivering the non-polar material, for example, to a customer. The non-polar material sample can be provided manually or automatically and can be continuously and/or periodically sampled, for example in a batch-wise manner. The non-polar material can be examined in situ by passing through the path of the electromagnetic radiation beam by moving through a pipe or tube that is constructed of a material that is transparent to the terahertz radiation beam such as, for example, PVC, HDPE, almost any polymer, glass, and/or quartz.

Testing non-polar materials for impurities using the techniques and devices described herein is believed to be nondestructive of the test samples. Because of this, a non-polar material test sample can be tested numerous times without destroying or negatively impacting the sample. Testing a non-polar material numerous times can produce multiple sets of data which can be averaged or otherwise processed by a controller, such as controller 30 in FIG. 1, to help reduce noise for instance.

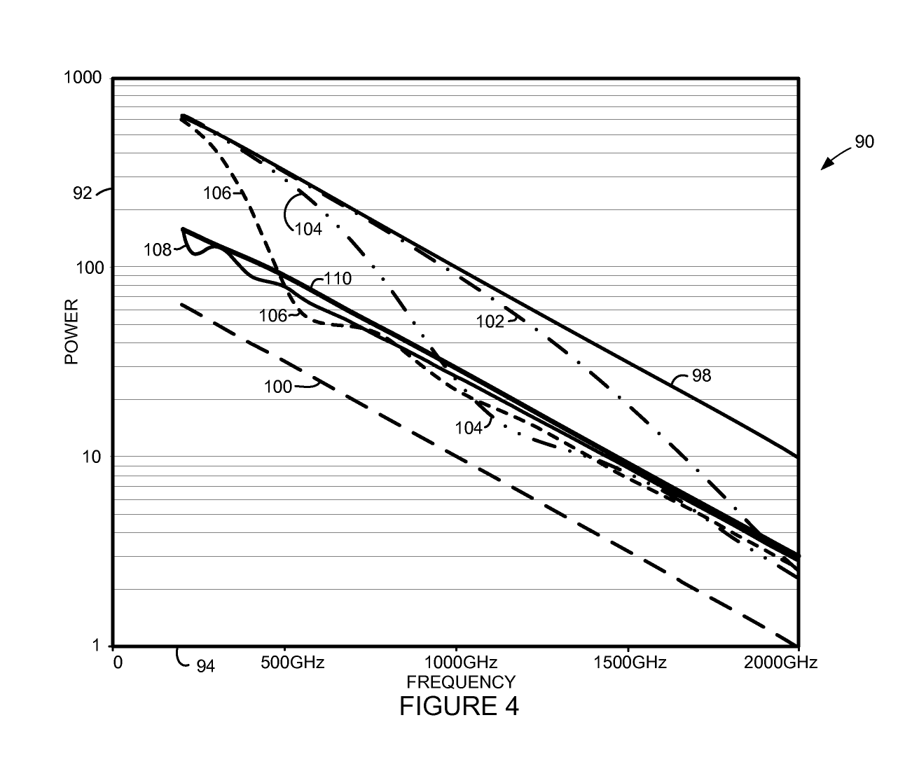

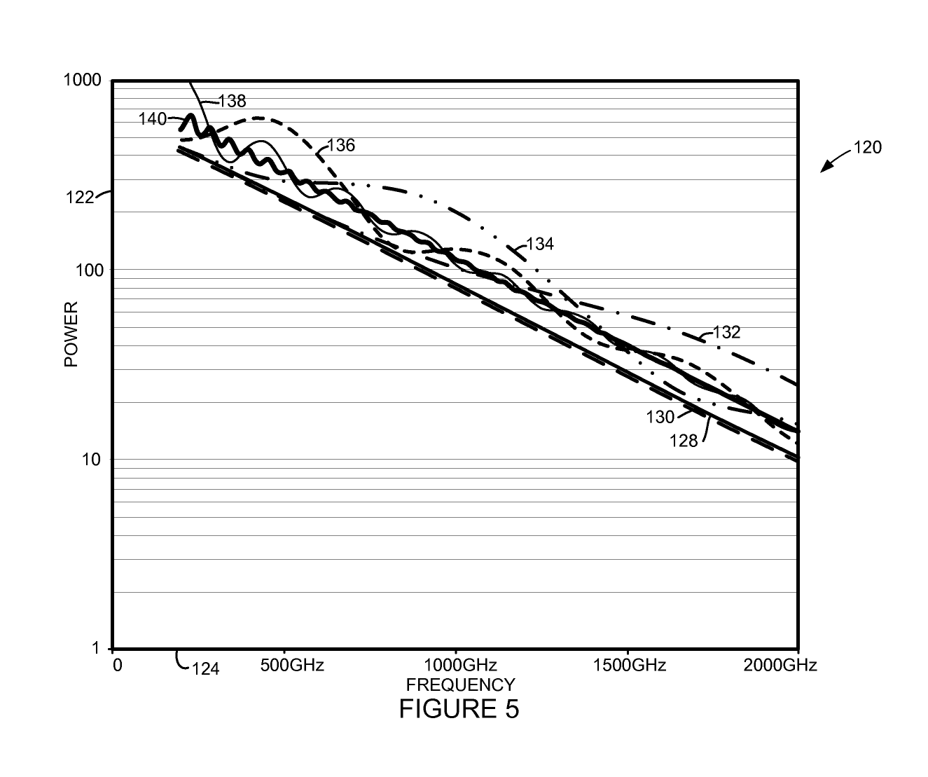

Referring now to FIGS. 4 and 5 in conjunction with FIG. 1, examples are shown of detected intensities of THz electromagnetic radiation transmitted (FIG. 4) through and reflected/scattered (FIG. 5) from a non-polar material such as, for example, oil. A graph 90 in FIG. 4 shows detected intensity levels of electromagnetic radiation transmitted through the non-polar material which can be used to identify impurity characteristics of impurities in the non-polar material. The data in FIG. 4 is illustrative of results which can be produced by transmitting terahertz electromagnetic radiation through a material that is essentially non-polar and essentially free of impurities; through the non-polar material when the non-polar material contains polar impurities; and through non-polar material when the non-polar material includes metal particles impurities of different sizes. Graph 120 in FIG. 5 shows examples of detected intensity levels of electromagnetic radiation reflected and scattered from impurities in the non-polar material which can be used to identify impurity characteristics of the impurities. The data in FIG. 5 is illustrative of results which can be produced by the reflection of terahertz electromagnetic radiation from the material that is essentially non-polar and essentially free of impurities; from the non-polar material when the non-polar material contains the polar impurities; and from the non-polar material when the non-polar material includes the metal particle impurities of different sizes. As shown in FIG. 1, the impurity detector can include both a transmission detector and a reflection/scattering detector. These detectors can be operated at the same time or separately and data collected from the reflection/scattering and transmission of terahertz electromagnetic radiation can be utilized simultaneously or separately for identifying impurity characteristics in the non-polar material.

Graph 90 (FIG. 1) includes an intensity level or amplitude 92 of transmitted radiation received by the transmission detector which is plotted against frequency 94 of the THz electromagnetic radiation beam. Graph 120 (FIG. 2) includes an intensity level or amplitude 122 of reflected radiation received by the reflection/transmission detector plotted against frequency 124 of the THz electromagnetic radiation beam.

Graph 90 includes a plot 98 and graph 120 includes a plot 128. Plots 98 and 128 represent intensity levels of transmitted and reflected electromagnetic radiation, respectively, from the non-polar material sample that is substantially without impurities. Plot 98 is indicative of the intensity levels of the electromagnetic radiation from the beam which passes through the non-polar material and falls on the transmission detector. Plot 128 is indicative of the electromagnetic radiation of the beam that is reflected and/or scattered and is detected by the reflection/scattering detector. Since the non-polar material is substantially without impurities and non-polar materials are essentially transparent to terahertz electromagnetic radiation, plot 98 is indicative of intensity levels of the portion of the electromagnetic radiation beam that is incident on the transmission detector for non-polar materials that are essentially free of impurities. On the other hand, since there are no impurities and the non-polar material is transparent to the radiation beam, nothing in the sample reflects or scatters the terahertz radiation and therefore plot 128 is indicative of essentially no radiation levels detected at the reflection/scattering detector. Plot 98 and plot 128 in graphs 90 and 120, respectively, can be used as a baseline data since these plots represent intensity levels, which can also be referred to as amplitudes, for non-polar materials substantially without impurities.

Plots 100 and 130 in graphs 90 and 120, respectively, are indicative of a situation in which the non-polar material includes a polar impurity. The polar impurity can be, for instance, the result of breakdown of lubricant, and/or can be other polar impurities such as water which can be a polar impurity introduced into lubricants, fuels, and other non-polar materials. As indicated by plot 100 in comparison to plot 98 in graph 90 the introduction of polar impurities causes a decrease in the transmission of the electromagnetic radiation through the non-polar material. This decrease is caused by the absorption of the electromagnetic radiation by the polar impurity. As indicated by plot 130 in graph 120, the introduction of the polar impurity has very little or no effect on the amount of electromagnetic radiation received by the reflection/scattering detector since the polar impurity does not reflect or scatter the electromagnetic radiation to any appreciable degree. In fact, plot 130 is essentially collinear with plot 128. This indicates that the amount of electromagnetic radiation reflected by the material having the polar impurity is essentially the same as the amount of electromagnetic radiation reflected by the essentially pure non-polar material. The irradiation of the non-polar material with the polar contaminants produces substantially straight plot lines which is indicative of the lack of a frequency dependence of the absorption of the polar impurity.

Plots 110 and 140 in graphs 90 and 120, respectively, are indicative of a situation in which the non-polar material includes a macroscopic scale metal particle impurity having a diameter of approximately 1 mm. Plots 110 and 140 can also be indicative of particle impurities larger than approximately 1 mm in diameter, and the particles can be metal, such as aluminum or steel, or can be other particle materials. As shown by plot 110 compared to plot 98, the transmitted radiation decreases and, as shown by plot 140 compared to plot 128, the reflected or scattered radiation increases when a macroscopic scale particle is introduced into the non-polar material. In the present example, the metal particles are aluminum which reflects the electromagnetic radiation towards the reflection/scattering detector. The intensity level or amplitude of the transmitted and reflected/scattered radiation does not have an appreciable frequency dependence because the metal particles are large compared to the wavelength of the radiation.

Plots 102 and 132 are for microscopic impurities having a diameter of approximately 25 μm; plots 104 and 134 are for microscopic impurities having a diameter of approximately 50 μm; plots 106 and 136 are for microscopic impurities having a diameter of approximately 100 μm; and plots 108 and 138 are for microscopic impurities having a diameter of approximately 250 μm. These microscopic impurities can be metal particles, soot, or other microscopic sized particulate impurities. As can be seen by comparing these pairs of plots, at different frequencies, transmission of the radiation through the non-polar material changes in correlation with the reflected and/or scattered radiation. For example, plot 106 decreases at about 500 GHz while plot 136 correspondingly increases at this frequency, and plot 104 decreases at about 1000 GHz while plot 134 correspondingly increases at this frequency. Thus, the intensity level of the transmission, reflection and scattering can have a frequency dependence that is dependent upon the size of the microscopic contaminant. The frequency dependence can be related to the Mie resonance of the particle and can be dependent upon the particle size.

As can be seen in graph 90 by comparison of plot 98 to plot 100, changes to the polarity of a non-polar material, such as by the introduction of a polar contaminant like water or by the breakdown of the non-polar material into polar contaminants, can typically be detected at frequencies below 500 GHz. In addition, as can be seen in graph 90 by comparison of plot 98 to plot 110, and in graph 120 by comparison of plot 128 with plot 140, the presence of large metallic particles, such as those having a diameter of about 1 mm or larger, can also be detected at frequencies below 500 GHz.

The presence of physically small impurities, such as particles of soot, can be detected by the application of higher frequencies due to the dependence of Mie scattering on the ratio of the particle size to the wavelength. Higher frequencies allow smaller particle sizes to be detected. For instance, in the examples shown in FIGS. 4 and 5, particles having an approximate diameter of 25 μm (plots 102 and 132) appear to produce frequency dependent variations in intensity levels from one another and baseline plots 98 and 128 at frequencies between about 1500 GHz and about 2000 GHz; particles having an approximate diameter of 50 μm (plots 104 and 134) appear to produce frequency dependent variations in intensity levels from one another and the baseline plots 98 and 128 at frequencies between about 1000 GHz to about 1200 GHz; particles having an approximate diameter of 100 μm (plots 106 and 136) appear to produce frequency dependent variations in intensity levels from one another and the baseline plots 98 and 128 at frequencies between about 500 GHz to about 700 GHz; and particles having an approximate diameter of 250 μm (plots 108 and 138) appear to produce frequency dependent variations in intensity levels from one another and the baseline plots 98 and 128 at frequencies between about 500 GHz to about 2000 GHz. Although graphs 90 and 120 show a range of frequencies from below 500 GHz to 2000 GHz, Applicants assert that the techniques described herein can be applied using other frequencies of terahertz radiation as well. As can be understood by the foregoing embodiments, the reflectivity, scattering and particle size characteristics of the impurities can be determined based at least in part on intensity levels of detected electromagnetic radiation.

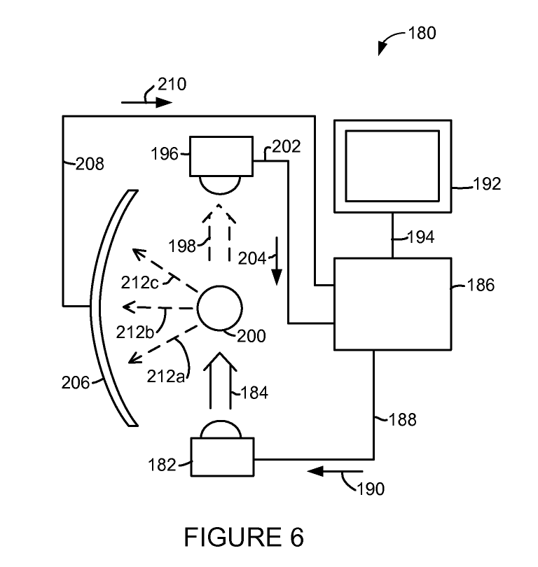

Referring now to FIG. 6, an impurity detector is generally indicated by the reference number 180. Impurity detector 180 includes an electromagnetic beam source 182 which selectively produces an electromagnetic radiation beam 184 having at least one frequency in the range of about 100 GHz to about 10 THz. Beam source 182 is connected to a controller 186 through a control line 188 for controlling the beam source using a signal 190. Impurity detector 180 can include a monitor 192 which can be connected to controller 186 using a cable 194. Impurity detector 180 also includes a transmission detector 196 which is arranged to detect a transmitted electromagnetic radiation 198 that has transmitted through a sample of non-polar material 200 which can have impurities or can be essentially free of impurities. Transmission detector 196 is connected to controller 186 through a data line 202 which carries a data signal 204 that is generated in response to the transmission detector receiving transmitted radiation 198.

Impurity detector 180 also includes a scatter/reflection detector array 206 that is connected to controller 186 through a data line 208. Detector array 206 generates a data signal 210 in response to receiving scattered/reflected electromagnetic radiation 212a-212c and data line 208 carries data signal 210 to controller 186 for processing. Detector array 206 is able to detect electromagnetic radiation that has been scattered and/or reflected from non-polar material 200 in multiple angles relative to the direction of travel of electromagnetic radiation beam 184, such as radiation 212a, 212, and 212c. Detector array 206 can distinguish between scattered/reflected radiations 212a, 212, and 212c, which are all characterized by different angles relative to radiation beam 184 and which can have different intensities. Scattering angle can depend on macroscopic properties of the non-polar material. For example, in instances where the non-polar material has a regular pattern, scattering can occur at a defined angle.

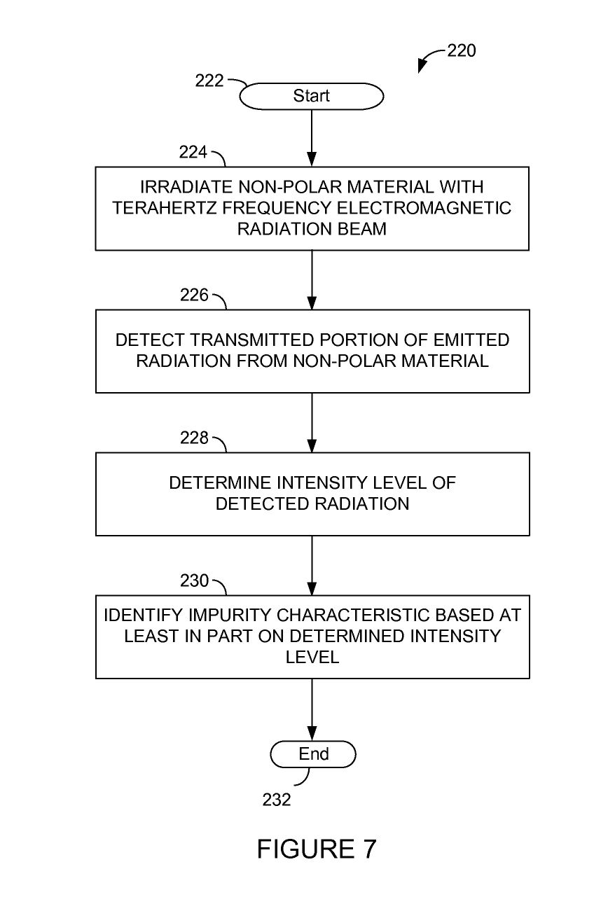

Referring now to FIG. 7 in conjunction with FIGS. 1 and 6, a method 220 is shown for detecting an impurity in an essentially non-polar material. Method 220 can utilize embodiments of the impurity detector shown in FIGS. 1 and 6, or other embodiments. Method 220 begins at start 222 and then proceeds to 224 where the non-polar material is irradiated with a beam of electromagnetic radiation. The electromagnetic radiation beam includes at least one frequency in a range of about 100 GHz to about 10 THz. One portion of the electromagnetic radiation beam is absorbed by the impurity in the non-polar material and another portion of the electromagnetic radiation is transmitted through the non-polar material. Method 220 then proceeds to 226 where the transmitted portion of the electromagnetic radiation is detected. Method 220 then proceeds to 228 where an intensity level of the detected electromagnetic radiation is determined. Method 220 then proceeds to 230 where an impurity characteristic is identified based at least in part on the determined intensity level. Method 220 then proceeds to 232 where the method ends.

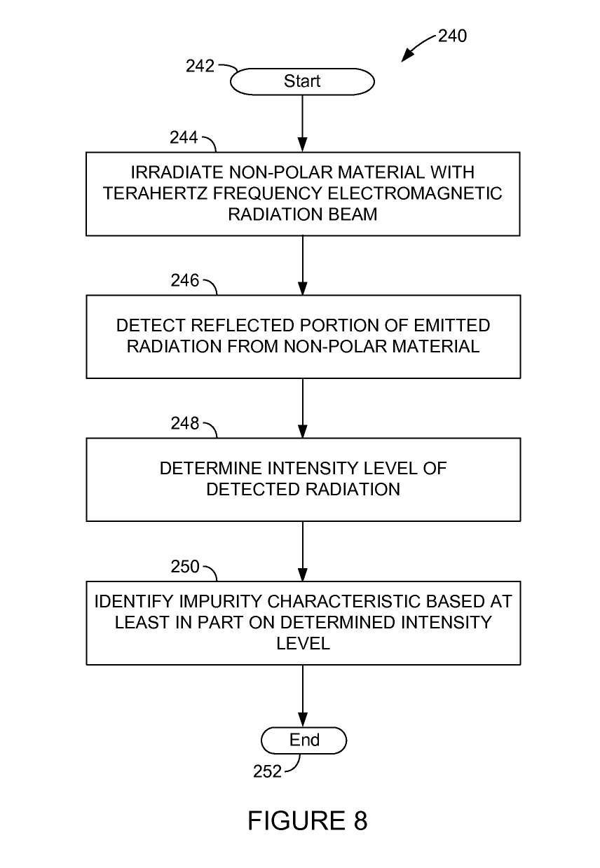

Referring now to FIG. 8 in conjunction with FIGS. 1 and 6, a method 240 is shown for detecting an impurity in an essentially non-polar material. Method 240 can utilize embodiments of the impurity detector shown in FIGS. 1 and 6 or other embodiments. Method 240 begins at start 242 and then proceeds to 244 where a non-polar material that includes an impurity is irradiated with an electromagnetic radiation beam. The electromagnetic radiation beam includes at least one frequency in a range of about 100 GHz to about 10 THz. One portion of the electromagnetic radiation beam interacts with the impurity in the non-polar material by reflecting from the impurity, and another portion of the electromagnetic radiation is transmitted through the non-polar material. Method 240 then proceeds to 246 where the reflected portion of the electromagnetic beam is detected. Method 240 then proceeds to 248 where an intensity level of the detected electromagnetic radiation is determined. Method 240 then proceeds to 250 where an impurity characteristic of the impurity in the non-polar material is identified based at least in part on the determined intensity level. Method 240 then proceeds to 252 where the method ends.

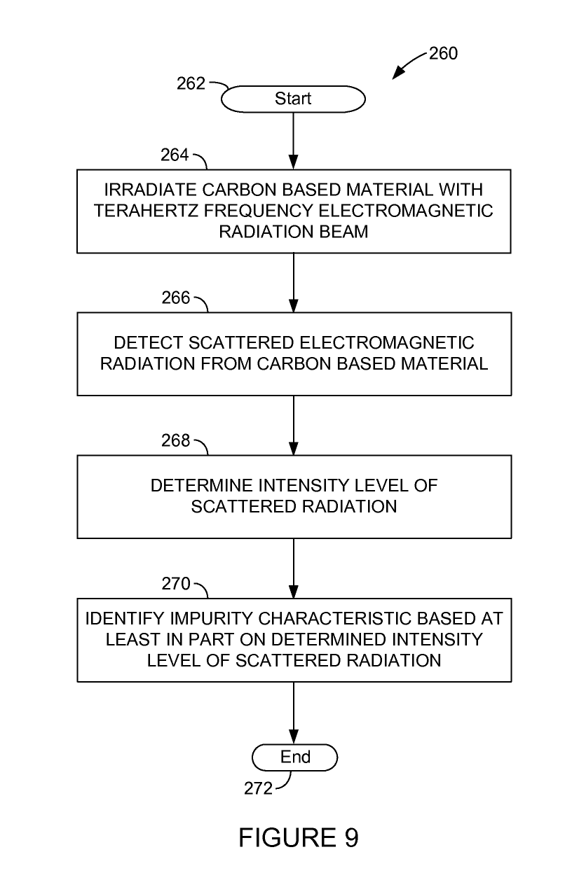

Referring now to FIG. 9 in conjunction with FIGS. 1 and 6, a method 260 is shown for detecting an impurity in a carbon based material. Method 260 can utilize embodiments of the impurity detector shown in FIGS. 1 and 6, or other embodiments. Method 260 begins at start 262 and then proceeds to 264 where the carbon based material is irradiated with a beam of electromagnetic radiation. The electromagnetic radiation beam includes at least one frequency in a range of about 100 GHz to about 10 THz. At least a portion of the electromagnetic radiation beam interacts with the impurity in such a way as to cause the impurity to produce a scattered electromagnetic radiation. Method 260 then proceeds to 266 where the scattered electromagnetic radiation is detected. Method 260 then proceeds to 268 where an intensity level of the detected scattered electromagnetic radiation is determined. Method 260 then proceeds to 270 where an impurity characteristic of the impurity in the carbon based material is identified based at least in part on the determined intensity level. Method 260 then proceeds to 272 where the method ends.

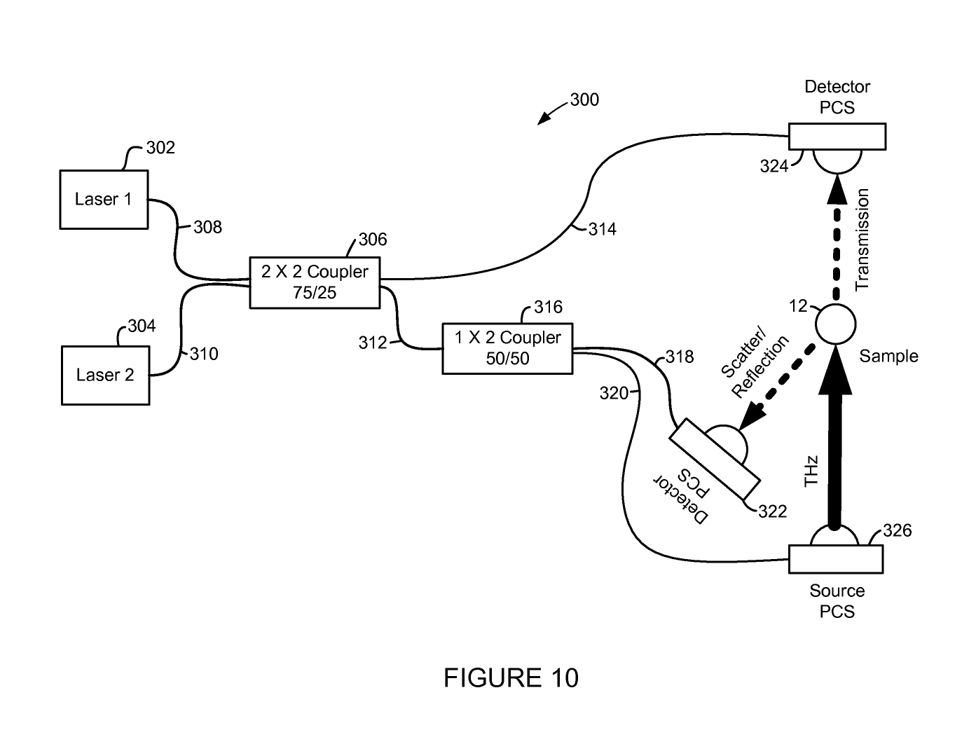

Referring now to FIG. 10 in conjunction with FIG. 1, an embodiment of an optical system which can be used for generating and detecting continuous wave THz frequency electromagnetic radiation is generally indicated by reference number 300. Optical system 300 utilizes photo mixing to produce the terahertz radiation and coherent detection to detect the terahertz radiation and can be incorporated into impurity detector 10 (FIG. 1) for these purposes. Controller 30 can be arranged to control optical system 300, detectors 20 and 22 each can be a photoconductive switch (PCS) configured for homodyne detection and source 16 can be a PCS configured for producing electromagnetic radiation beam 18. Optical system 300 includes a first laser source 302 and a second laser source 304. Laser sources 302 and 304 can be controlled to produce laser light at slightly different frequencies from one another. Laser sources 302 and 304 are connected to an optical coupler 306 through optical fibers 308 and 310, respectively. Coupler 306 can be a 2×2 75/25 optical coupler which combines the light from the laser sources and outputs the combined light with 75% of the power on a fiber 312 and 25% of the power on a fiber 314. Fiber 314 feeds the combined light to a transmission detector 324, which in this instance is a detector PCS. Fiber 314 feeds the combined light to a 1×2 50/50 optical coupler 316 which outputs the combined light with 50% of the power on a fiber 318 and 50% of the power on a fiber 320. Fiber 318 feeds the combined light to a scatter/reflection detector 322, which is also a detector PCS in the present embodiment. In another embodiment, the scatter/reflection detector can be an array such as that shown in FIG. 6. Fiber 320 feeds the combined light to a source PCS 326 which produces the electromagnetic radiation beam in response thereto. The controller can operate to turn the laser sources on and off and can control the frequencies produced by either one or both of the laser sources. By controlling the laser sources, the frequency of the electromagnetic radiation beam can be controlled. The detector PCSs are connected to the controller using data lines (not shown, but understood to be present in FIG. 10), to carry data signals from the detectors to the controller.

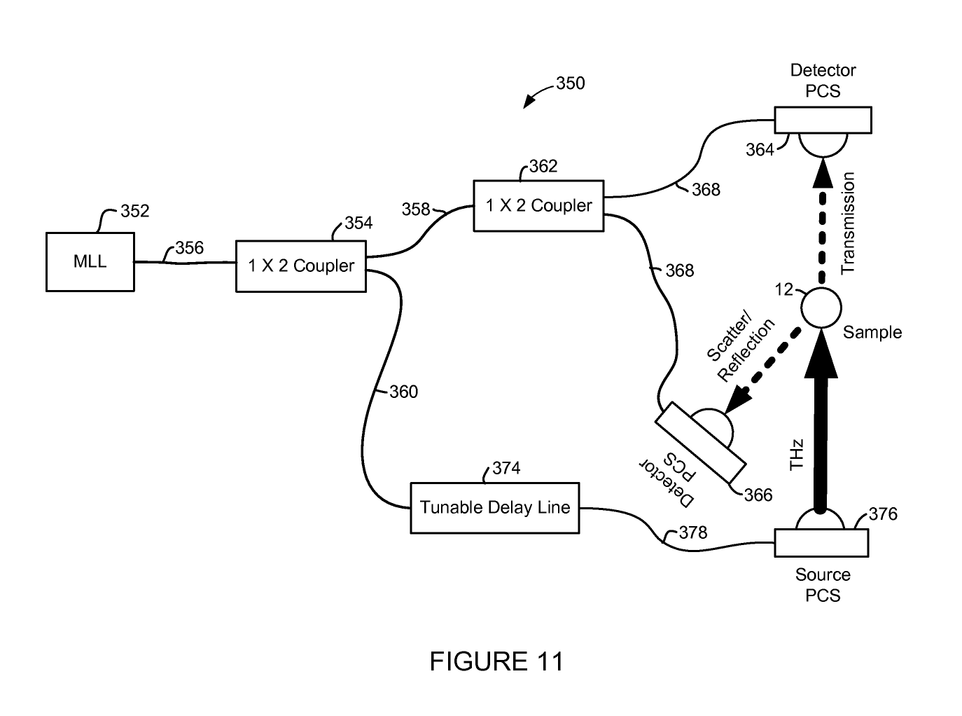

Referring now to FIG. 11 in conjunction with FIG. 1, an embodiment of an optical system which can be used for generating and detecting pulsed terahertz frequency electromagnetic radiation is generally indicated by reference 350. Optical system 350 includes a pulse source 352, which can be a mode locked laser (MLL), for producing pulses of laser light. The pulsed light is carried from the pulse source to a 1×2 coupler 354 over a fiber 356. Coupler 356 divides the light and feeds the light into fibers 358 and 360. A coupler 362 divides the light and feeds the light to PCS transmission detector 364 and PCS scatter/reflection detector 366 over fibers 368 and 370, respectively. In another embodiment, the scatter/reflection detector can be an array such as that shown in FIG. 6. Optical system 350 includes a tunable delay line 374 which receives the pulsed light from fiber 360. The tunable delay line feeds the pulsed light to a source PCS 376 over a fiber 378. The source PCS generates the terahertz electromagnetic radiation beam in pulses in response to receiving the pulsed light. The tunable delay line allows the measurement of the pulse form on the detectors. The controller of the impurity detector can control the operation of pulse source 352 and tunable delay line 374. Transmission detector PCS 364 and scatter/reflection PCS 366 are connected to the controller using data lines, not shown in FIG. 11 but understood to be present, to carry data signals from the detectors to the controller. The impurity detectors described herein can also utilize other techniques, including non-optical techniques, for producing and detecting the terahertz radiation. For example, the pulsed terahertz frequency electromagnetic radiation can be generated using a system that is not fiber based or which only makes limited use of fiber.

Various embodiments of detectors and techniques are described herein that can be used for detecting the presence, quantity, type and/or other aspects of impurities in a non-polar material. These detectors and techniques can be used for determining the efficacy of lubricants, fuels and other non-polar materials which can be useful for equipment maintenance and operation purposes and for human safety in instances where the safety is dependent on the reliable operation of machinery such as, for example, emergency generators, airplanes and ambulances. The detectors and techniques described herein are non-destructive to the material being tested so a material can be tested multiple times and the material can be used for its intended purpose even after testing.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for detecting an impurity in a non-polar material, comprising:
irradiating the non-polar material with a beam of electromagnetic radiation having at least one frequency in a range of about 100 GHz to about 10 THz such that at least a portion of the electromagnetic radiation beam interacts with the impurity in the non-polar material resulting in electromagnetic radiation emerging from the non-polar material;
detecting an intensity level of the emergent electromagnetic radiation from the non-polar material; and
identifying an impurity characteristic of the impurity in the non-polar material based, at least in part, on the detected intensity level of the electromagnetic radiation as influenced by the interaction of the electromagnetic radiation beam with the impurity.

2. The method as defined in claim 1, wherein the electromagnetic radiation beam interacts with the impurity by preventing the portion of the beam from transmitting through the non-polar material and the emergent electromagnetic radiation is another portion of the electromagnetic radiation beam that is transmitted through the non-polar material.

3. The method as defined in claim 2, wherein identifying the impurity characteristic includes identifying a concentration characteristic of the impurity in the non-polar material.

4. The method as defined in claim 2, wherein the impurity is a product of degradation of the non-polar material such that the impurity exhibits a dipole moment which causes the impurity to absorb terahertz frequency electromagnetic radiation and wherein the portion of the electromagnetic radiation beam interacts with the impurity by being, at least in part, absorbed by the impurity and wherein the detected electromagnetic radiation is used to identify the impurity based on the dipole moment impurity characteristic.

5. The method as defined in claim 1, wherein the non-polar material is a hydrocarbon and the impurity is a product of the degradation of the hydrocarbon that exhibits a dipole moment and wherein identifying the impurity characteristic includes identifying the hydrocarbon degradation impurity based, at least in part, on the dipole moment impurity characteristic as characterized by the detected intensity level.

6. The method as defined in claim 1, wherein the non-polar material is a fluorocarbon that includes an additive and the impurity is a product of degradation of the additive that exhibits a dipole moment and identifying the fluorocarbon additive degradation impurity based, at least in part, on the dipole moment impurity characteristic as characterized by the detected intensity level.

7. The method as defined in claim 1, wherein identifying the impurity characteristic includes characterizing the impurity as a degradation material of the non-polar material based on absorption of the electromagnetic radiation beam.

8. The method as defined in claim 1, wherein the non-polar material is irradiated with the beam of electromagnetic radiation having a frequency range of about 100 GHz to about 500 GHz and the impurity is a polar impurity.

9. The method as defined in claim 1, wherein the portion of the electromagnetic radiation beam interacts with the impurity by reflecting from the impurity and wherein detecting the intensity level of the emergent electromagnetic radiation includes detecting radiation that has been, at least in part, reflected by the impurity in the non-polar material.

10. The method as defined in claim 9, wherein the impurity includes particles that have an electromagnetic radiation reflection characteristic and wherein the portion of the electromagnetic beam interacts with the particles at least in part by reflection and the detected intensity level of the emergent electromagnetic radiation identifies the particles based at least in part on the electromagnetic radiation reflection characteristic.

11. The method as defined in claim 1, wherein the detected intensity level of the emergent electromagnetic radiation identifies the impurity as a metal contaminant material based on a reflection impurity characteristic.

12. The method as defined in claim 1, wherein detecting the intensity level of the emergent electromagnetic radiation includes detecting electromagnetic radiation that has been scattered by the impurity in the non-polar material.

13. The method as defined in claim 12, wherein the impurity includes particles having a dimensional characteristic that produces Mei scattering in response to the interaction with the electromagnetic radiation beam and detecting of the intensity level of the emergent electromagnetic radiation includes detecting a directional characteristic responsive to the Mei scattering.

14. The method as defined in claim 13, further comprising;
detecting an angle of the scattering relative to the electromagnetic radiation beam.

15. The method as defined in claim 12, wherein the impurity particles include soot and the emergent electromagnetic radiation identifies the impurity characteristic as Mei scattering caused by the interaction of the electromagnetic radiation beam with the particles of soot.

16. The method as defined in claim 15, including selecting the frequency within the range of the electromagnetic radiation beam based, at least in part, on the Mei scattering of soot particles.

17. The method as defined in claim 1, including identifying the impurity as soot based on Mie scattering of the electromagnetic radiation beam.

18. The method as defined in claim 1, wherein the non-polar material is a hydrocarbon material, and further comprising:
selecting the frequency of the electromagnetic radiation beam based on the material being a hydrocarbon.

19. The method as defined in claim 1, wherein the non-polar material is a fluorocarbon material, and further comprising:
selecting the frequency of the electromagnetic radiation beam based on the material being a fluorocarbon.

20. The method as defined in claim 1, further comprising:
changing the frequency of the electromagnetic radiation beam to exhibit different frequencies at different times within the range of about 100 GHz to about 10 THz.

21. The method as defined in claim 20, wherein changing the frequency of the electromagnetic radiation beam includes scanning the frequency through the different frequencies.

22. The method as defined in claim 20, wherein the different frequencies are distinct separate frequencies and changing the frequency of the electromagnetic radiation beam includes stepping the frequency through the distinct separate frequencies.

23. The method as defined in claim 20, wherein detecting the intensity level of the emergent electromagnetic radiation includes detecting the emergent electromagnetic radiation as a plurality of reflected intensity levels at a plurality of the different frequencies of the electromagnetic radiation beam reflected from the impurity in the non-polar material; and
identifying a type of the impurity based at least in part on the detected plurality of frequency intensity levels.

24. The method as defined in claim 23, wherein identifying the type of impurity includes identifying metal particle contaminants.

25. The method as defined in claim 1, wherein detecting the intensity level of the emergent electromagnetic radiation includes detecting an intensity level of a single frequency and identifying the type of the impurity based at least in part on the detected single frequency intensity level.

26. The method as defined in claim 25, wherein identifying the type of impurity includes identifying a soot particle based on Mie scattering.

27. The method as defined in claim 1, including pulsing the electromagnetic radiation beam such that the electromagnetic radiation beam simultaneously produces a plurality of different frequencies within the range of about 100 GHz to about 10 THz.

28. The method as defined in claim 1, further comprising:
determining a baseline intensity level of the emergent electromagnetic radiation for the non-polar material without the impurity, and establishing an impurity content characteristic of the non-polar material based on the detected intensity level and the baseline intensity level of the emergent electromagnetic radiation.

29. The method as defined in claim 28, wherein establishing the impurity content characteristic includes determining a difference between the baseline intensity level and the detected intensity level.

30. The method as defined in claim 29, wherein establishing the impurity content characteristic includes determining the difference between the baseline intensity level and the detected intensity level at more than one frequency within the range.

31. The method as defined in claim 1, wherein the impurity includes different impurity types having different impurity characteristics identifying includes the impurity characteristic of at least one impurity type.

32. The method as defined in claim 31, wherein identifying includes establishing the impurity type based at least in part on the identified impurity characteristic.

33. A method for detecting an impurity in a carbon-based material, comprising:
irradiating the carbon based material with a beam of electromagnetic radiation having at least one frequency in the range of about 100 GHz to about 10 THz such that at least a portion of the electromagnetic radiation beam interacts with the impurity in the carbon based material to cause the impurity to produce a scattered electromagnetic radiation;
detecting the scattered electromagnetic radiation from the carbon based material;
determining an intensity level of the detected scattered electromagnetic radiation; and
identifying an impurity characteristic in the carbon based material based, at least in part, on the determined intensity level of the detected scattered electromagnetic radiation.

34. A method as defined in claim 33, wherein determining the intensity level includes determining intensity levels at different angles relative to the electromagnetic radiation beam.

35. A method for detecting an impurity in a non-polar material, comprising:
irradiating the non-polar material with a beam of electromagnetic radiation having at least one frequency in the range of about 100 GHz to about 10 THz such that one portion of the electromagnetic radiation beam is absorbed by the impurity in the non-polar material and another portion of the electromagnetic radiation is transmitted through the non-polar material;
detecting the transmitted portion of the electromagnetic radiation from the non-polar material;
determining an intensity level of the detected electromagnetic radiation; and
identifying an impurity characteristic of the impurity in the non-polar material based, at least in part, on the determined intensity level of the detected electromagnetic radiation.

36. The method as defined in claim 35, wherein the impurity is a polar impurity resulting from the degradation of the non-polar material that exhibits a dipole moment and selecting the frequency of the electromagnetic radiation beam such that at least part of the electromagnetic radiation beam is absorbed by the polar contaminant.

37. The method as defined in claim 36, wherein the non-polar material is a liquid fuel and the polar impurity is water and irradiating the non-polar material includes selecting the frequency based, at least in part, on an electromagnetic absorption characteristic of water.

38. The method as defined in claim 36, wherein the non-polar liquid is a liquid fuel and the polar impurity is water and irradiating the non-polar material includes selecting the frequency based at least in part on an electromagnetic transmission characteristic of the liquid fuel.

39. A method for detecting an impurity in a non-polar material, comprising:
irradiating the non-polar material with a beam of electromagnetic radiation having at least one frequency in the range of about 100 GHz to about 10 THz such that one portion of the electromagnetic radiation beam is reflected by the impurity in the non-polar material and another portion of the electromagnetic radiation is transmitted through the non-polar material;
detecting the reflected portion of the electromagnetic radiation from the non-polar material;
determining an intensity level of the detected electromagnetic radiation; and
identifying an impurity characteristic of the impurity in the non-polar material based, at least in part, on the determined intensity level of the detected electromagnetic radiation.

40. An impurity detector for detecting an impurity in a non-polar material, comprising:
a terahertz frequency electromagnetic radiation beam source configured to produce an electromagnetic radiation beam having at least one frequency in a range of about 100 GHz to about 10 THz and arranged to irradiate the non-polar material such that a terahertz frequency electromagnetic radiation emerges from the non-polar material in response to the irradiation;
a terahertz frequency detector arranged to receive at least a portion of the emergent terahertz frequency electromagnetic radiation and to produce a detector signal responsive thereto containing information related to a characteristic of the impurity; and
a controller configured to receive the detector signal and to use the detector signal to identify the impurity characteristic based on the detector signal.

41. The impurity detector as defined in claim 40, wherein the terahertz frequency detector is arranged to receive emergent electromagnetic radiation that has been transmitted through the non-polar material.

42. The impurity detector as defined in claim 40, wherein the terahertz frequency detector is arranged to receive emergent electromagnetic radiation that has been reflected by the impurity in the non-polar material.

43. The impurity detector as defined in claim 40, wherein the terahertz frequency detector is arranged to receive emergent electromagnetic radiation that has been scattered by the impurity in the non-polar material.

44. The impurity detector as defined in claim 43, wherein the terahertz frequency detector is an array of detectors.

45. The impurity detector as defined in claim 40, wherein the aforesaid terahertz frequency detector is a first detector that is arranged to receive emergent electromagnetic radiation that has been transmitted through the non-polar material, the impurity detector further comprising:
a second terahertz frequency detector arranged to receive emergent electromagnetic radiation that has been reflected by the impurity in the non-polar material.

46. The impurity detector as defined in claim 40, wherein the terahertz frequency electromagnetic radiation beam source includes a photoconductive switch.

47. The impurity detector as defined in claim 40, wherein the terahertz frequency electromagnetic radiation beam source is a continuous wave source.

48. The impurity detector as defined in claim 40, wherein the terahertz frequency electromagnetic radiation beam source is a pulsed source.

49. The impurity detector as defined in claim 40, wherein the terahertz frequency electromagnetic radiation beam source includes a photoconductive switch.
